(19) United States
(12) Patent Application Publication
(10) Pub. No.: US 2004/0089524 A1
(43) Pub. Date: May 13, 2004

(54) Wireless power switch control device

(76) Inventor: Chao Chuan Chien, Hsin-Chuang City (TW)

Correspondence Address: QUINTERO LAW OFFICE, 1617 BROADWAY, 3RD FLOOR, SANTA MONICA, CA, 90404, US

(21) Appl. No.: 10/292,691

(22) Filed: Nov. 12, 2002

(51) Int. Cl. H01H 35/02

(52) U.S. Cl. 200/61.52; 340/686.1

(57) ABSTRACT

A wireless power switch control device, comprising: comprising: a detection and transmission circuit for detecting an obliquity of an object, upon the obliquity of said object reaching to a specified level, said detection and transmission circuit will transmit a wireless signal; and a receiving and control circuit upon receiving the wireless signal from said detection and transmission circuit will turn off a power of a outlet so as to prevent sparking of an electric wire.

### FIELD OF THE INVENTION

The present invention relates generally to a power switch. More particularly, the present invention relates to a wireless power switch control device.

### BACKGROUND OF THE INVENTION

Generally speaking, a Christmas tree in accordance with the prior art has a plurality of lamps. These lamps are connected to a power outlet via an electric wire. Upon the Christmas tree tipping and providing power continually, may be arisen a sparking of an electric wire and then caused a fire accident. In addition, a wire-control Christmas tree is provided in the market, which controlled the power ON/OFF by way of a wire and a switch. However, if the Christmas tree tipping and not turning off the power timely by the switch, may be arisen a sparking of an electric wire and then caused a fire accident yet.

As a result, an improved wireless power switch control device that reduces damage by the sparking of an electric wire is needed.

### SUMMARY OF THE INVENTION

It is an object of the present invention to provide a wireless power switch control device for protecting the outlet and providing security of power.

In accordance with one embodiment of the invention, an wireless power switch control device is provided comprising: a detection and transmission circuit for detecting an obliquity of an object, upon the obliquity of the object reaching to a specified level, the detection and transmission circuit transmits a wireless signal; and a receiving and control circuit upon receiving the wireless signal from the detection and transmission circuit turns off a power of a outlet so as to prevent sparking of an electric wire.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an assembly view of a wireless power switch control device in accordance with one embodiment of the present invention.

FIG. 2 is a block diagram of a detection and transmission circuit in accordance with one embodiment of the present invention.

FIG. 3 is a block diagram of a receiving and control circuit in accordance with one embodiment of the present invention.

### DESCRIPTION OF THE PREFERRED EMBODIMENTS

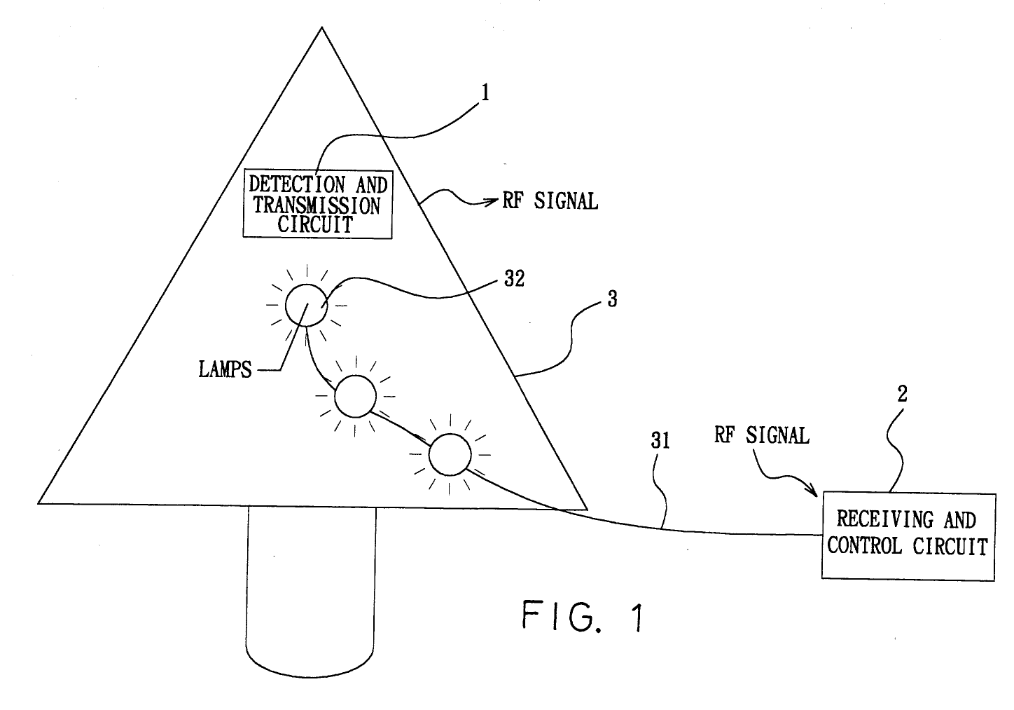

Referring first to FIG. 1, there is an assembly view of a wireless power switch control device in accordance with one embodiment of the present invention. The wireless power switch control device comprises: a detection and transmission circuit 1; and receiving and control circuit 2.

Wherein, the detection and transmission circuit 1 is positioned on an object 3 such as a Christmas tree, a building, or the like for detecting an obliquity of the object 3. A plurality of lamps 32 also positioned on the object 3 for providing light in various color and patterns. The lamps 32 are connected each other in sequence by a wire and then connected to the receiving and control circuit 2 via an electric wire 31. Upon the obliquity of the object 3 reaching to a specified level (for example 30 degree, or the like), the detection and transmission circuit 1 transmits a wireless signal to the receiving and control circuit 2, upon receiving the wireless signal the receiving and control circuit turns off a power of a outlet (shown in FIG. 3) so as to prevent sparking of an electric wire 31.

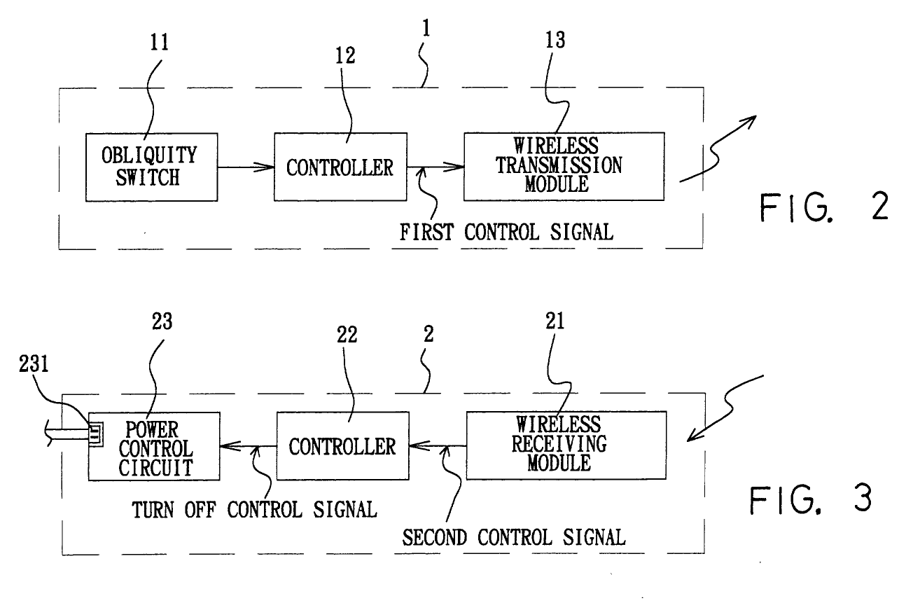

Referring to FIG. 2 is a block diagram of a detection and transmission circuit in accordance with one embodiment of the present invention. The detection and transmission circuit 1 further comprising: an obliquity switch 11; a controller 12; and a wireless transmission module 13.

Wherein, the obliquity switch 11 is placed in the object 3 for detecting the obliquity of the object 3. According to one embodiment of the present invention, the obliquity switch 11 further comprising two conductive plates (not shown) and a metal ball (not shown), upon the obliquity of the object 3 reaching to a specified level (for example 30 degree, or the like), the metal ball leaved form one of the conductive plates so as to make the obliquity switch 11 becoming a open circuit state. Wherein, the controller 12 coupled to the obliquity switch 11, upon the obliquity of the object 3 reaching to a specified level generates a first control signal; and the wireless transmission module 13 coupled to the controller 12, upon receiving the first control signal from the controller 12 transmits the wireless signal, wherein the wireless signal is for example but not limit to a radio frequency (RF) signal or a infrared (IR) signal and the wireless transmission module 13 is for example but not limit to a radio frequency (RF) module or a infrared (IR) module.

Referring to FIG. 3 is a block diagram of a receiving and control circuit in accordance with one embodiment of the present invention. The receiving and control circuit 2 that is placed closely to the power source further comprises: a wireless receiving module 21; a controller 22; and a power control circuit 23.

Wherein, the wireless receiving module 21 upon receiving the wireless signal from the detection and transmission circuit 13 will recover the wireless signal into a second control signal; the controller 22 coupled to the wireless receiving module 21, upon receiving the second control signal will generate a turn off control signal, the wireless receiving module 21 is for example but not limit to a radio frequency (RF) module or a infrared (IR) module; and the power control circuit 23 coupled to the controller 22 comprising at least one outlet 231, upon receiving the turn off control signal will turn off the power of the outlet 231, therefore, the sparking of the electric wire 31 will not arise.

While the invention has been described with reference to a preferred embodiment thereof, it is to be understood that modifications or variations may be easily made without departing from the spirit of this invention, which is defined by the appended claims.

What is claimed is:

1. A wireless power switch control device, comprising:
a detection and transmission circuit for detecting an obliquity of an object, upon the obliquity of the object reaching to a specified level, said detection and transmission circuit transmits a wireless signal; and
a receiving and control circuit upon receiving the wireless signal from said detection and transmission circuit turns off a power of a outlet so as to prevent sparking of an electric wire.

2. A wireless power switch control device as claimed in claim 1, wherein the wireless signal is a radio frequency (RF) signal preferably.

3. A wireless power switch control device as claimed in claim 1, wherein the wireless signal is an infrared (IR) signal preferably.

4. A wireless power switch control device as claimed in claim 1, wherein said detection and transmission circuit further comprising:
an obliquity switch for detecting the obliquity of said object;
a controller coupled to said obliquity switch, upon the obliquity of said object reaching to a specified level generates a first control signal; and
a wireless transmission module coupled to said controller, upon receiving the first control signal from said controller transmits the wireless signal.

5. A wireless power switch control device as claimed in claim 4, wherein said obliquity switch further comprising two conductive plates and a metal ball, upon the obliquity of said object reaching to a specified level, said metal ball is leaved form one of said conductive plates so as to make said obliquity switch becoming a open circuit state.

6. A wireless power switch control device as claimed in claim 1, wherein said receiving and control circuit further comprising:
a wireless receiving module, upon receiving the wireless signal from said detection and transmission circuit recovers the wireless signal into a second control signal;
a controller coupled to said wireless receiving module, upon receiving the second control signal generates a turn off control signal; and
a power control circuit coupled to said controller comprising at least one outlet, upon receiving the turn off control signal turns off the power of said outlet.

7. A wireless power switch control device as claimed in claim 1, wherein said object is a building preferably.

8. A wireless power switch control device as claimed in claim 1, wherein said object is a Christmas tree preferably.
